(19) United States
(12) Patent Application Publication
(10) Pub. No.: US 2026/0104319 A1
(43) Pub. Date: Apr. 16, 2026

(54) METHOD FOR DETERMINING A LOAD ON A BEARING OF A GEARWHEEL OF A GEARBOX, DEVICE, AND GEARBOX COMPRISING A DEVICE

(71) Applicants: ZF Friedrichshafen AG, Friedrichshafen (DE); ZF Wind Power Antwerpen N.V., Lommel (BE)

(72) Inventors: Mauricio PINEROS, Munich (DE); Sebastian ORTMANN, Lohr (DE); Sebastian SCHMIDT, Zellingen (DE)

(21) Appl. No.: 19/357,216

(22) Filed: Oct. 14, 2025

(30) Foreign Application Priority Data
Oct. 15, 2024 (DE) 102024209976.7

(51) Int. Cl. G01M 13/045; G01M 13/028

(52) U.S. Cl. CPC G01M 13/045; G01M 13/028

(57) ABSTRACT

A method for determining a load on a bearing of a gearwheel of a gearbox is provided. The method includes determining a gearwheel mating frequency at a gearwheel mating point of the gearwheel of the gearbox based on an acceleration signal of the gearbox, and determining a load of the bearing based on the determined gearwheel mating frequency and a reference value.

### CROSS REFERENCE TO RELATED APPLICATIONS

This application claims benefit to German Patent Application No. 102024209 976.7, filed on October 15, 2024, which is hereby incorporated by reference herein.

### FIELD

The present disclosure relates to a method for determining a load on a bearing of a gearwheel of a gearbox, to a device, and to a gearbox comprising a device.

### BACKGROUND

Methods for determining bearing failures are known from the prior art. These methods involve determining frequencies that are associated with failure of an inner ring or an outer ring of the bearing, a rolling member of the bearing, or a cage of the bearing. The frequencies determined in the process are also referred to as bearing failure frequencies.

### SUMMARY

In an embodiment, the present disclosure provides a method for determining a load on a bearing of a gearwheel of a gearbox. The method includes determining a gearwheel mating frequency at a gearwheel mating point of the gearwheel of the gearbox based on an acceleration signal of the gearbox and determining a load of the bearing based on the determined gearwheel mating frequency and a reference value.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a flowchart of a method according to one or more embodiments of the present disclosure; and

FIG. 2 is a schematic view of a gearbox, according to one or more embodiments of the present disclosure.

### DETAILED DESCRIPTION

A first aspect relates to a method for determining a load on a bearing of a gearwheel of a gearbox.

The gearbox may be any kind of gearbox that provides for gearwheel mating. The gearbox may be a planetary gearbox, for example. The gearwheel of the gearbox may be mated with another gearwheel of the gearbox. The bearing of the gearwheel may depend on the type of gearbox and the operating conditions. In a planetary gearbox, the gearwheel may be a planet gear of the planetary gearbox. In this case, the planet gear may, for example, be mated with a ring gear of the planetary gearbox. The bearing of the gearwheel may be a bearing of the planet gear. The bearing may, for example, be a roller bearing, a sliding bearing, a needle bearing, or a ball bearing.

The load on the bearing may indicate a defect in the bearing. The load may thus be an indication of failure of the bearing. The load on the bearing may indicate damage to the bearing. The load may thus be an indication of imminent failure of bearing. The load may characterize deformation of the gearwheel and thus a shifting of the force away from a reference application of force at the gearwheel mating point.

The method comprises determining a gearwheel mating frequency at a gearwheel mating point of the gearwheel of the gearbox on the basis of an acceleration signal of the gearbox.

The gearwheel mating frequency may characterize a vibration caused by the mating of the gearwheels. The gearwheel mating frequency may characterize a quality of the gearwheel mating, for example the quality of an application of force at the gearwheel mating point. The gearwheel mating frequency may include a carrier frequency, an upper sideband, and a lower sideband.

The acceleration signal may comprise an acceleration of a vibration of the gearbox. The acceleration signal may be representative of the acceleration of the vibration of the bearing. The acceleration signal may be recorded by means of a sensor. The acceleration signal may be obtained. Obtaining the signal may involve fetching, for example from a database.

The method comprises determining a load of the bearing on the basis of the determined gearwheel mating frequency and a reference value.

The determined gearwheel mating frequency of the bearing may be an indication of the load. For example, a change in the running of the bearing may cause the determined gearwheel mating frequency to diverge from the reference value. This deviation may be an indication of divergent behavior of the bearing. The divergence may thus be an indication of a load of the bearing. The degree of divergence may be an indication of a level of the load.

The reference value may characterize a gearwheel mating frequency of the bearing in an undamaged state. The reference value may, for example, be obtained from a database. In continuous monitoring, for example, the reference value may be recorded, for example at the start of the monitoring, and stored in a readable manner, for example in a database. As a result, the gearwheel mating frequency specific to the mating of the gearwheels can be recorded and used as a reference value for the continuous measurement.

Using the method, vibrations can be recorded and processed such that the load of the bearing can be detected. The method can thus make it possible to detect vibrations in a bearing and thus identify failure of a bearing. The load may arise as early as a stage in which no physical defects are yet present on the bearing, meaning that a damage pulse is not in the range of the bearing failure frequencies. A frequency range occurring owing to the load may be lower than a rotational frequency of the bearing. Therefore, when determining the load of the bearing, the method can record and take into account in potentially damaging vibrations in a low frequency range in good time. This makes it possible to identify, in good time, loads on the bearing that may point to imminent failure of the bearing. Thus, the method allows maintenance work to be reduced since bearings can be replaced in good time, thus enabling safe operation and optimal gearwheel mating.

In one embodiment, the acceleration signal may be an acceleration of a vibration on a housing of the gearbox.

The acceleration of the vibration on the housing of the gearbox can be measured at such a point on the housing that the measurement is representative of the acceleration of the vibration at the gearwheel mating point. The acceleration of the vibration on the housing of the gearbox can be measured at such a point on the housing that the measured signal represents the acceleration of the vibration at the gearwheel mating point in as isolated a manner as possible. Here, “isolated” can mean with little or no interference. “Isolated” can also mean the minimizing of superimposed noise signals. It may also be conceivable for the measurement to be taken at or near the gearwheel mating point.

As a result, a measurement that is as representative as possible of the acceleration of the vibrations at the gearwheel mating point can be obtained.

In one embodiment, the gearwheel mating point may be a gearwheel mating point between a planetary gearbox and a ring gear of the planetary gearbox, and the bearing may be a bearing of the planet gear.

Determining a load of the bearing of the planet gear, and thus identifying an imminent failure, may avoid the planetary gearbox being out of action for a relatively long period of time.

In one embodiment, determining the gearwheel mating frequency may comprise filtering the acceleration signal.

The filter may be a frequency filter, for example a bandpass filter. The relevant frequencies may depend on the gearbox. As a result, the range in which the acceleration signal is filtered may be varied depending on the gearbox. This allows the acceleration signal to be filtered in a variable manner depending on the gearbox used.

In this way, the acceleration signal can be reduced to relevant frequencies. This can reduce the quantity of acceleration signal data that have to be processed further. This may speed up a process for further processing the data.

Furthermore, determining the gearwheel mating frequency may comprise breaking the filtered acceleration signal down into a phase signal and an amplitude signal.

In this way, the acceleration signal can be converted into an analytical form. The broken-down acceleration signal can thus have a combination of amplitude information and phase information. The amplitude information may be the amplitude signal. The phase information may be the phase signal. The acceleration signal may be broken down by means of a Hilbert transform, for example. In this way, frequencies that are difficult to detect in the time range, for example owing to a noise signal superimposed on the acceleration signal, can be rendered detectable by transforming the filtered acceleration signal into the frequency range.

Furthermore, determining the gearwheel mating frequency may comprise extracting the amplitude signal on the basis of the broken-down acceleration signal.

As described above, the broken-down acceleration signal is in the form of a combination of the phase signal and the amplitude signal. These two pieces of information are separably interlinked by the breaking-down. For example, the amplitude signal can be extracted by determining an absolute value of the broken-down acceleration signal. The amplitude signal may be an indication of the maximum excursion of the acceleration signal and thus characterize the intensity of the acceleration of the vibration at the gearwheel mating point.

Furthermore, determining the gearwheel mating frequency may comprise determining the frequency spectrum of the extracted amplitude signal.

By way of example, this step may be carried out by means of a Fourier transform or a fast Fourier transform. In this way, the extracted amplitude signal can be broken down into the frequency components in order to determine, on that basis, the distribution of frequency components of the amplitude signal.

Furthermore, determining the gearwheel mating frequency may comprise determining the gearwheel mating frequency on the basis of the determined frequency spectrum.

The determined frequency spectrum may characterize which frequencies are present in the extracted amplitude signal and at what intensity. The gearwheel mating frequency can be determined therefrom.

In one embodiment, the filtering of the acceleration signal may be bandpass filtering of the acceleration signal. The breaking-down of the filtered acceleration signal into a phase signal and an amplitude signal may be a Hilbert transform of the filtered acceleration signal. The extraction of the amplitude signal on the basis of the broken-down acceleration signal may be the definition of the absolute value of the broken-down acceleration signal. The determination of the frequency spectrum may be the application of a fast Fourier transform on the basis of the absolute value. The determination of the gearwheel mating frequency on the basis of the determined frequency spectrum may be the determination of the gearwheel mating frequency on the basis of an output of the fast Fourier transform.

In one embodiment, filtering the acceleration signal may comprise determining an effective-value signal of the acceleration signal and filtering the effective-value signal.

The effective-value signal may be an effective value of the acceleration signal. The effective-value signal may thus characterize an average power of the acceleration signal. The effective-value signal can be determined by means of a root mean square (RMS). Using the effective-value signal may help suppress noise.

In one embodiment, before the step of extracting the amplitude signal, a signal processing step is carried out by adding together the filtered acceleration signal and the broken-down acceleration signal.

As a result of the breaking-down, the signal may have a noise component, which may lead to a deterioration in the signal quality. Adding together the filtered acceleration signal and the broken-down acceleration signal in the signal processing step can suppress or at least reduce the noise. Adding together the filtered acceleration signal and the broken-down acceleration signal can lead to the signal strength being amplified. This can also bring about an improved signal-to-noise ratio (SNR). This can lead to the amplitude signal being amplified. The amplitude signal can thus be extracted on the basis of a sum of the two signals added together. In this way, the signal quality can be improved. Improving the signal quality can bring the extracted amplitude signal to a quality that leads to an improvement in the accuracy of the gearwheel mating frequency.

A second aspect relates to a device configured to carry out steps of the method according to the first aspect. Embodiments, and advantages of the second aspect also constitute features, embodiments of the first aspect.

A third aspect relates to a gearbox comprising a device configured to carry out steps of the method according to the first aspect, the gearbox comprising a first gearwheel and a second gearwheel, the first gearwheel and the second gearwheel being mated together, and the gearbox comprising at least one bearing of the first gearwheel. Embodiments of the third aspect also constitute features, embodiments of the first and second aspects.

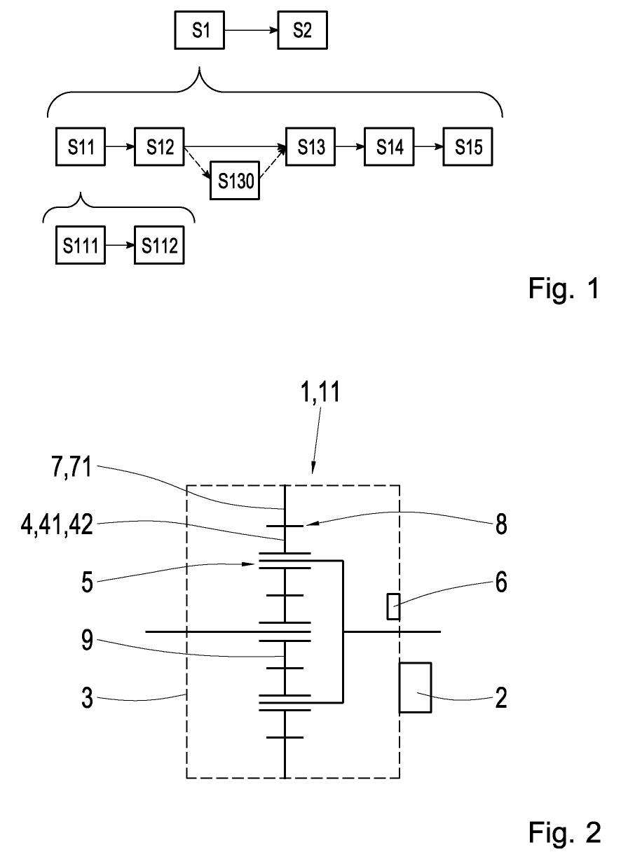

FIG. 1 is a flowchart of a method according to one or more embodiments of the present disclosure.

The method comprises determining a gearwheel mating frequency S1 at a gearwheel mating point 8 of the gearwheel 4 of the gearbox 1 on the basis of an acceleration signal of the gearbox 1.

The step of determining the gearwheel mating frequency S1 comprises filtering the acceleration signal S11.

In the embodiment shown in FIG. 1, the filtering of the acceleration signal S11 is bandpass filtering. The filtered range of the bandpass filter depends on the gearbox 1 used. In the present case, the bandpass filter filters frequencies in the range from 100 Hz to 1500 Hz. Thus, only this frequency range is taken into consideration for the further processing of the signal. Filtering the acceleration signal S11 comprises determining an effective-value signal S111 of the acceleration signal and filtering the effective-value signal S112.

Furthermore, the method comprises breaking the filtered acceleration signal down S12 into a phase signal and an amplitude signal and extracting the amplitude signal S13 on the basis of the broken-down acceleration signal. In addition, the method comprises determining the frequency spectrum S14 of the extracted amplitude signal and determining the gearwheel mating frequency S15 on the basis of the determined frequency spectrum.

The breaking-down of the filtered acceleration signal S12 into a phase signal and an amplitude signal is a Hilbert transform of the filtered acceleration signal. Before the step of extracting the amplitude signal S13, a signal processing step is carried out by adding together S130 the filtered acceleration signal and the broken-down acceleration signal. In this way, the signal quality is improved. The signal processing step by addition S130 is optional, as indicated by the dashed arrows between steps S12 and S13 in the flowchart in FIG. 1. The extraction of the amplitude signal S13 on the basis of the broken-down acceleration signal is the definition of the absolute value of the broken-down acceleration signal. An envelope of the broken-down acceleration signal is thus obtained. The envelope characterizes pulse events in the broken-down acceleration signal. The determination of the frequency spectrum S14 is the application of a fast Fourier transform on the basis of the absolute value. The distribution of frequency components of the absolute value is determined in this way. The determination of the gearwheel mating frequency S15 on the basis of the determined frequency spectrum is the determination of the gearwheel mating frequency on the basis of an output of the fast Fourier transform. The distribution of frequency components is thus used to determine the gearwheel mating frequency S15.

Furthermore, the method comprises determining a load of the bearing S2 on the basis of the determined gearwheel mating frequency and a reference value. The reference value is a determined gearwheel mating frequency recorded at the start of operation of the gearbox 1. Next, the reference value is stored in a readable manner in a database. When the load of the bearing S2 is determined, the determined gearwheel mating frequency is compared with the reference value. If a divergence is noted in the process, this is an indication of atypical bearing behavior and thus of damage to the bearing. In this case, the degree of divergence is an indicator of the severity of the damage.

FIG. 2 is a schematic view of a gearbox 1 in the form of a planetary gearbox 11.

The planetary gearbox 11 comprises a device 2 configured to carry out steps of the above-described method. Furthermore, the planetary gearbox 11 comprises a first gearwheel 41 in the form of a planet gear 42, a second gearwheel 7 in the form of a ring gear 71, and a sun gear 9. Moreover, the planetary gearbox 11 comprises an acceleration sensor 6, which is arranged on a housing 3 of the planetary gearbox 11.

The ring gear 71 is mated 8 with the planet gear 42. The planet gear 42 is likewise mated with the sun gear 9.

The acceleration sensor 6 records the acceleration signal, which represents an acceleration of a vibration on the housing 3 of the gearbox 1. In this case, the acceleration sensor 6 is arranged on the housing 3 such that the recorded signal is representative of the vibration at the gearwheel mating point 8 between the ring gear 71 and the planet gear 42.

The device 2 can obtain the acceleration signal recorded by the acceleration sensor 6 and process it in accordance with the method depicted in Fig. 1 in order to determine a load of the bearing 5 of the planet gear 42.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### REFERENCE SIGNS

1 Gearbox

11 Planetary gearbox

2 Device

3 Housing

4 Gearwheel

41 First gearwheel

42 Planet gear

5 Bearing

6 Acceleration sensor

7 Second gearwheel

71 Ring gear

8 Gearwheel mating point

9 Sun gear

S1 Determining a gearwheel mating frequency on the basis of an acceleration signal

S2 Determining a load of the bearing

S11 Filtering the acceleration signal

S12 Breaking down the filtered acceleration signal

S13 Extracting the amplitude signal

S14 Determining the frequency spectrum

S15 Determining the gearwheel mating frequency on the basis of the determined frequency spectrum

S111 Determining an effective-value signal

S112 Filtering the effective-value signal

S130 Signal processing by addition

1. A method for determining a load on a bearing of a gearwheel of a gearbox, comprising:
determining a gearwheel mating frequency at a gearwheel mating point of the gearwheel of the gearbox based on an acceleration signal of the gearbox; and
determining a load of the bearing based on the determined gearwheel mating frequency and a reference value.

2. The method according to claim 1, wherein the acceleration signal is an acceleration of a vibration on a housing of the gearbox.

3. The method according to claim 1, wherein the gearwheel mating point is a gearwheel mating point between a planet gear of a planetary gearbox and a ring gear of the planetary gearbox, and the bearing is a bearing of the planet gear.

4. The method according to claim 1, wherein determining the gearwheel mating frequency comprises:
filtering the acceleration signal;
breaking down the filtered acceleration signal into a phase signal and an amplitude signal;
extracting the amplitude signal based on the broken-down filtered acceleration signal;
determining a frequency spectrum of the extracted amplitude signal; and
determining the gearwheel mating frequency based on the determined frequency spectrum.

5. The method according to claim 4, wherein the filtering of the acceleration signal is bandpass filtering of the acceleration signal;
the breaking-down of the filtered acceleration signal into the phase signal and the amplitude signal being a Hilbert transform of the filtered acceleration signal;
the extraction of the amplitude signal based on the broken-down acceleration signal being a definition of the absolute value of the broken-down acceleration signal;
the determination of the frequency spectrum being an application of a fast Fourier transform based on the absolute value; and
the determination of the gearwheel mating frequency based on the determined frequency spectrum being the determination of the gearwheel mating frequency based on an output of the fast Fourier transform.

6. The method according to claim 4, wherein filtering the acceleration signal comprises determining an effective-value signal of the acceleration signal and filtering the effective-value signal.

7. The method according to claim 4, wherein before the step of extracting the amplitude signal, a signal processing step is carried out by adding together the filtered acceleration signal and the broken-down acceleration signal.

8. A device configured to carry out steps of the method according to claim 1.

9. A gearbox comprising a device configured to carry out steps of the method according to claim 1, wherein the gearbox comprises a first gearwheel and a second gearwheel, wherein the first gearwheel and the second gearwheel are mated together, and wherein the gearbox comprises at least one bearing of the first gearwheel.
